(19) United States
(12) Patent Application Publication
(10) Pub. No.: US 2026/0141726 A1
(43) Pub. Date: May 21, 2026

(54) AI-POWERED TRAFFIC CONTROL SYSTEM AND METHOD FOR AUTONOMOUS MONITORING AND MANAGEMENT OF TRAFFIC VIOLATIONS AND CONDITIONS

(71) Applicant: Ali Almarouf, RIYADH (SA)

(72) Inventor: Ali Almarouf, RIYADH (SA)

(21) Appl. No.: 18/954,683

(22) Filed: Nov. 21, 2024

(51) Int. Cl. G06V 20/54; B60Q 1/50; G06V 20/58; G08G 1/054

(52) U.S. Cl. CPC G06V 20/54; B60Q 1/545; G06V 20/58; G08G 1/054; G06V 2201/08

(57) ABSTRACT

The present disclosure provides an AI-powered traffic control system (102) mounted on a vehicle (301) for autonomous monitoring and management of traffic violations and conditions. The system includes at least one AI-powered camera (201) to capture images or video, detect traffic violations, conditions, and unsafe driving behaviours using image recognition and machine learning algorithms; a speed detection device (202) to measure vehicle speed; and an adaptive light system (203) to deliver real-time visual feedback to surrounding drivers. A processor (501) analyses data from the camera (201) and speed detection device (202), controlling the adaptive light system (203) and communicating with external systems. Memory (502) stores data for reporting and post-incident analysis. A method for implementing the system includes initializing components, capturing data, analysing violations, providing feedback, and ensuring privacy protection. This system (102) enables decentralized traffic management, enhancing road safety and regulatory compliance in varied traffic environments.

### FIELD

The present disclosure relates to the field of traffic control and monitoring systems, particularly focusing on an AI-powered system and method integrated with civilian vehicles. This system and method are designed to enhance road safety, reduce congestion, and autonomously detect and manage traffic violations.

### BACKGROUND ART AND PRIOR ART

Urbanization and population growth have led to significant increases in vehicular traffic, resulting in chronic congestion, frequent traffic violations, and a rising rate of road accidents globally. Despite the deployment of various traffic control systems and enforcement mechanisms, urban areas continue to face challenges in maintaining efficient traffic flow and ensuring road safety. These issues stem from the inherent limitations of traditional traffic management infrastructure, which typically includes fixed traffic lights, static surveillance cameras, and government-operated monitoring vehicles.

Current traffic systems are predominantly stationary and rely heavily on fixed infrastructure, which restricts their ability to monitor areas without permanent installations. This infrastructure-centric approach limits coverage and results in uneven monitoring across different zones, particularly in high-density urban centers and underserved regions. Additionally, static systems lack the flexibility to adjust to dynamic traffic patterns in real time, often leading to delayed response times in addressing congestion or violations.

Another limitation of conventional systems is their reliance on driver compliance and static signaling, which do not adapt to changing road conditions or provide real-time feedback to drivers. Traffic control heavily depends on the discretion of individual drivers, and violations such as speeding, distracted driving, and lane encroachment are challenging to monitor consistently. Many violations go undetected, resulting in inefficient enforcement, increased risk of accidents, and reduced accountability for unsafe driving behaviors.

Moreover, traffic monitoring and enforcement are largely centralized in government-operated vehicles and control centers, which require significant operational costs and labor. This dependency limits scalability and coverage, especially in areas with limited resources or high-traffic demands. The restricted presence of government monitoring also creates gaps in traffic regulation, as many locations remain under-monitored or completely unmonitored. Consequently, traffic management becomes reactive rather than proactive, with limited ability to prevent incidents before they occur.

Traditional systems also struggle to integrate disparate data sources effectively, leading to fragmented monitoring that fails to provide a comprehensive picture of traffic conditions. This lack of integration further compounds the challenge of ensuring consistent, real-time traffic monitoring and violation detection across all regions.

Given these limitations, there is a critical need for an innovative traffic control system that can autonomously detect and address traffic violations, adapt to real-time traffic conditions, and provide consistent monitoring across all areas. Such a system should be easily deployable on civilian vehicles, allowing for decentralized traffic management without the need for extensive infrastructure or government-operated vehicles. This enables a scalable solution that not only reduces traffic congestion and enhances road safety but also provides continuous, autonomous monitoring and real-time feedback to improve driver compliance

### OBJECTS

Some of the objects of the present disclosure are described herein below:

An object of the present disclosure is to provide an AI-powered traffic control system and method designed to enhance road safety and reduce traffic congestion through continuous, decentralized monitoring.

Another object of the present disclosure is to integrate an AI-powered system mounted on civilian vehicles for comprehensive traffic condition monitoring and management, even in areas without fixed infrastructure.

Yet another object of the present disclosure is to implement an AI-powered external traffic light unit capable of providing real-time feedback to surrounding vehicles, thereby promoting safer driving practices and adherence to traffic laws.

An additional object of the present disclosure is to detect a wide range of traffic violations, including but not limited to littering, seatbelt non-compliance, and mobile phone use while driving, ensuring continuous enforcement even when vehicles are stationary.

A further object of the present disclosure is to power the system through multiple energy sources, including vehicle batteries, solar energy, wind energy, and an internal battery, ensuring sustainable and uninterrupted operation across various conditions.

An objective of the present disclosure is to provide predictive capabilities to the system, enabling it to map the precise positions of surrounding vehicles and detect lane violations, even when direct visual confirmation is unavailable.

Another object of the present disclosure is to facilitate vehicle-to-vehicle communication, allowing equipped vehicles to share data for enhanced accuracy in violation detection and coordinated traffic management.

Still another object of the present disclosure is to allow the system to serve as the vehicle's identity marker, detecting and reporting any attempts to deactivate or remove it, thus ensuring consistent monitoring and compliance.

An additional objective of the present disclosure is to record accident data and calculate fault percentages, automatically generating and transmitting reports to law enforcement and insurance companies for efficient post-incident response.

Other objects and advantages of the present disclosure will become apparent from the detailed description and accompanying drawings, which illustrate preferred embodiments and are not intended to limit the scope of the present disclosure.

### SUMMARY

In view of the foregoing, embodiments herein provide a system and method of AI-powered traffic control system for safer roads and reduced congestion.

The present disclosure relates to an AI-powered traffic control system designed for autonomous monitoring and management of traffic violations and conditions. The system is mounted on a vehicle and includes essential components such as at least one AI-powered camera, a speed detection device, an adaptive light system, a processor, and a memory.

The AI-powered camera is configured to capture images or video of the surrounding environment and detect traffic violations, traffic conditions, and unsafe driving behaviors using advanced image recognition and machine learning algorithms. The speed detection device measures the speed of surrounding vehicles to identify instances of speeding. The adaptive light system provides real-time visual feedback to surrounding vehicles, with dynamically adjusted color-coded signals to promote safe driving behaviors based on detected conditions and violations.

The processor is operatively connected to the AI-powered camera, speed detection device, and adaptive light system, analyzing data in real time to detect traffic violations and conditions. It controls the adaptive light system for immediate driver feedback and communicates data to external systems, including central servers or other nearby vehicles, to support coordinated traffic management. The memory stores data on detected violations, traffic conditions, and accident information, enabling retrieval for post-incident analysis and reporting.

The method for implementing this AI-powered traffic control system involves initializing the system upon vehicle start or in a stationary state, capturing real-time environmental data through the AI-powered camera, measuring vehicle speeds with the speed detection device, and analyzing data via the processor to detect traffic violations and conditions. The adaptive light system provides real-time feedback to drivers, and data is selectively recorded and transmitted to external entities, enabling efficient data storage and seamless communication with other traffic management systems. Additionally, privacy-protection algorithms are used to anonymize sensitive information, ensuring compliance with privacy standards.

This AI-powered traffic control system enhances road safety, optimizes traffic flow, and enables autonomous, decentralized traffic monitoring and enforcement without reliance on fixed infrastructure, offering a scalable solution adaptable to various traffic environments.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers across different figures indicates similar or identical items.

FIG. 1 illustrates an AI-powered traffic control system mounted on top of a vehicle, in accordance with an embodiment herein;

FIG. 2 illustrates a schematic representation of the AI-powered traffic control system, in accordance with an embodiment herein;

FIG. 3 shows a schematic view of the AI-powered traffic control system monitoring surrounding vehicles on the road, in accordance with an embodiment herein;

FIG. 4 depicts the architecture of the AI-powered traffic control system, in accordance with an embodiment herein;

FIG. 5 presents a block diagram of a unified external system placed on top of the vehicle, in accordance with an embodiment herein; and

FIG. 6 illustrates a flowchart of the AI-powered traffic control system, designed for safer roads and reduced congestion, in accordance with an embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As previously discussed, there is a need for an AI-powered traffic control system capable of reducing traffic violations, minimizing congestion, and enhancing road safety without relying on government-operated vehicles. Specifically, there is a need for a real-time, AI-powered traffic control system that can be deployed on standard civilian vehicles. This traffic control system empowers civilian vehicles to monitor traffic conditions autonomously and detect a broad range of violations, even while stationary.

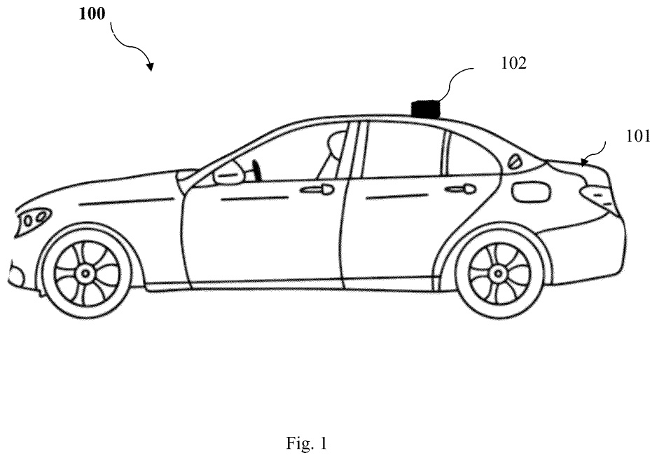

The embodiments herein provide a system and method for an AI-powered traffic control system designed to create safer roads and reduce congestion. Referring now to the accompanying drawings, FIGS. 1 through 6 illustrate the preferred embodiments, with consistent reference numerals denoting corresponding features across the figures.

FIG. 1 illustrates a vehicle (100) equipped with an AI-powered traffic control system (102), according to an embodiment. The traffic control system (102) can be configured to monitor driving behaviors, detect traffic violations, and optimize traffic management to reduce congestion and enhance road safety. The system (102) can be implemented in various configurations based on specific installation requirements.

In an embodiment, the traffic control system (102) can be mounted externally on the vehicle (100) to provide optimal visibility and monitoring coverage. Alternatively, the system (102) or its components may be placed entirely or partially inside the vehicle (100), either in the front or rear sections, depending on design preferences, space constraints, or operational needs. This flexible placement allows for customized implementations tailored to different vehicle types and monitoring requirements.

This adaptability enables the system (102) to be seamlessly integrated without compromising the vehicle's aesthetics or functionality, making it suitable for diverse vehicle configurations. In an embodiment, the system (102) can operate in multiple states, including active monitoring when the vehicle (100) is in motion and stationary monitoring when the vehicle (100) is parked, allowing it to continuously monitor traffic conditions and detect violations. This flexibility allows the system (102) to operate independently of fixed monitoring infrastructure, supporting autonomous and decentralized traffic management.

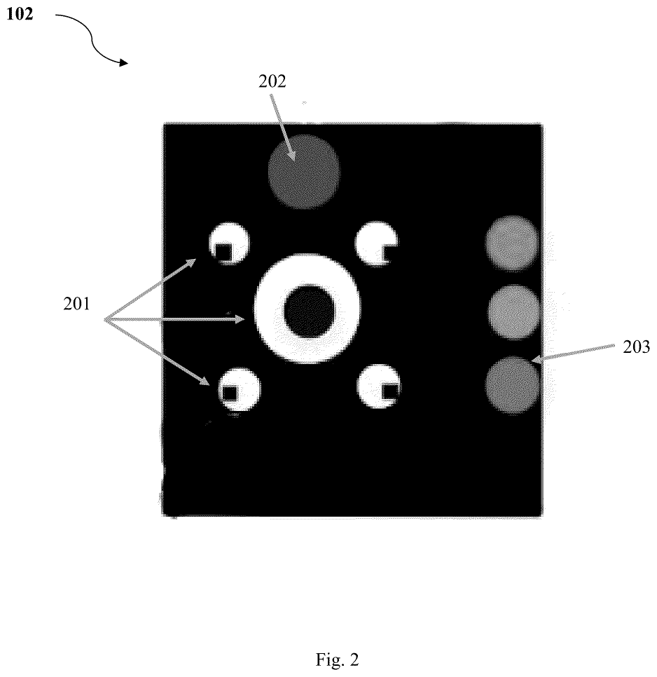

FIG. 2 illustrates a schematic of the AI-powered traffic control system (102) with key components that enable the system's monitoring and enforcement capabilities, according to an embodiment. The AI-powered traffic control system (102) may include, but is not limited to, one or more AI-powered cameras (201), a speed detection device (202), and an adaptive light system (203). These components can be arranged in various configurations to optimize performance based on the vehicle type and specific monitoring requirements.

In an embodiment, the system (102) may include one or more cameras (201) positioned at the front, rear, or sides of the vehicle (100), depending on the desired level of coverage. In one embodiment, the cameras (201) may be positioned on the vehicle's roof, front bumper, or rear bumper to provide an unobstructed view of the surrounding traffic. This setup can be ideal for detecting traffic violations, monitoring lane changes, and offering a 360-degree field of view. Additionally, one or more cameras (201) may be positioned near the windshield or rear window to capture driver behaviors, such as mobile phone use or seatbelt compliance, while being shielded from external elements.

In an embodiment, the cameras (201) can be configured to continuously monitor the environment, capturing high-resolution images and videos to detect various traffic violations and unsafe driving behaviors. Unlike conventional cameras that simply record footage, the cameras (201) may utilize advanced image recognition and machine learning algorithms to identify and classify objects, vehicles, and behaviors in real time. These capabilities can enable the cameras (201) to detect complex violations that require context-aware analysis, such as distracted driving (e.g., mobile phone use), malfunctioning lights, improper vehicle identification, and seatbelt non-compliance.

The AI-powered cameras (201) may also analyze driving patterns to identify aggressive behaviors, such as tailgating, sudden lane changes, and illegal drifting, which can pose safety risks. Additionally, these cameras (201) may assist in speed regulation by recognizing visual indicators and vehicle dynamics associated with speeding, contributing to the enforcement of safe driving speeds. The cameras (201) may also monitor environmental violations, such as littering, by identifying objects thrown from windows, thereby promoting road cleanliness. This monitoring capability can remain active even when the vehicle (100) is stationary, allowing the cameras (201) to provide continuous, autonomous oversight without reliance on external monitoring infrastructure.

In an embodiment, the cameras (201) may be equipped with enhanced capabilities to capture and process images in low-light or nighttime conditions, using AI algorithms for noise reduction and object detection to maintain image clarity. This feature can ensure that traffic violations are detected regardless of lighting conditions, surpassing conventional cameras that often struggle in dark environments.

To ensure compliance with privacy standards, the cameras (201) may incorporate privacy-protection algorithms, enabling selective data capture and anonymization of sensitive information, such as blurring faces or license plates when not directly involved in violations. This feature allows the cameras (201) to focus solely on traffic monitoring while protecting individual privacy.

In an embodiment, the cameras (201) can also use event-based recording, where footage is stored only when a violation or incident is detected. This feature may optimize data storage and processing by focusing data on key events, unlike conventional cameras that record continuously.

Further, the cameras (201) may be configured to integrate with traffic management networks and nearby vehicles (V2V communication), enabling real-time data sharing, traffic flow management, and collaborative incident response. This integration can support a coordinated approach to traffic management that conventional cameras cannot achieve independently.

In an embodiment, the speed detection device (202) can be positioned based on the vehicle's design and the intended functionality. An external speed detection device (202) on the front or rear bumper may allow for accurate speed measurement of vehicles ahead or behind, especially in congested or high-speed conditions. Alternatively, the speed detection device (202) may be embedded within the dashboard, with sensors that operate through the vehicle's windows, providing protection for the device while still enabling accurate speed detection.

In one embodiment, the speed detection device (202) can be configured to measure the speed of surrounding vehicles for real-time enforcement of speeding violations. The speed detection device (202) may utilize sensors, GPS, and algorithms to measure speeds across multiple lanes and traffic densities, identifying vehicles that exceed speed limits. By distinguishing between normal speed fluctuations and actual violations, the speed detection device (202) can help ensure accurate enforcement.

In furtherance to an embodiment, the speed detection device (202) may track multiple vehicles at once, facilitating speed regulation in urban or highway settings. When a speeding violation is detected, the speed detection device (202) can send an alert to the adaptive light system (203) to notify the offending driver. Additionally, the speed detection device (202) may log speed violations for future analysis or reporting, reducing the need for fixed speed cameras or government-operated monitoring vehicles.

In accordance with an embodiment, the adaptive light system (203) can provide visual feedback to surrounding drivers and may be positioned externally or internally based on visibility needs and aesthetic considerations. In one embodiment, mounting the adaptive light system (203) on the vehicle's roof or rear bumper may ensure high visibility for trailing drivers, allowing the system to issue signals such as green, orange, or red lights for proceed, caution, or stop instructions. Alternatively, the adaptive light system (203) can be integrated within the vehicle's existing lighting, such as rear lights or side mirrors, to reduce visual impact while still providing clear feedback.

In furtherance to an embodiment, the adaptive light system (203) can project real-time feedback to surrounding drivers. It may dynamically adjust its color-coded signals (green, orange, red) based on real-time traffic conditions and violations detected by the system (102), such as speeding or aggressive driving.

In furtherance to an embodiment, the adaptive light system (203) can be highly visible under various environmental conditions and may use high-intensity LEDs with adaptive brightness to ensure clarity without glare. This adaptability can ensure that drivers see and respond to signals in various lighting and weather conditions.

In furtherance to an embodiment, the adaptive light system (203) may include directional indicators to target specific vehicles, such as those following too closely. Proximity-based adjustments can further promote safe driving behaviors, advising tailgating vehicles to maintain safer distances. Sequential signaling may communicate complex instructions, and customization based on traffic environments allows the system (203) to adapt to different road conditions, enhancing safety.

Together, in an embodiment, the cameras (201), speed detection device (202), adaptive light system (203) form a comprehensive monitoring and enforcement solution. This AI-powered traffic control system (102) can enhance road safety and promote compliance, enabling autonomous and decentralized traffic management on civilian vehicles without traditional infrastructure reliance.

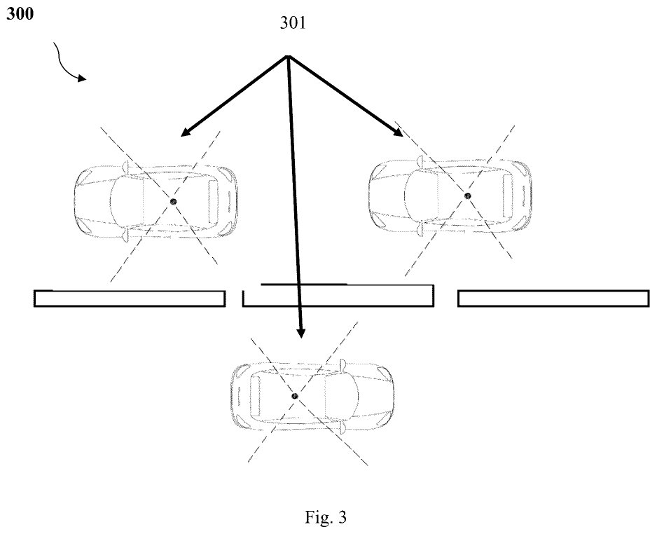

FIG. 3 illustrates a schematic view of an AI-powered traffic control system (102) monitoring surrounding vehicles (301) on the road, according to an embodiment. The AI-powered traffic control system (102) can be mounted on top of a vehicle (300), as shown in FIG. 3. In an embodiment, these systems may be strategically placed on top of vehicles (300) to monitor surrounding vehicles (301) and capture relevant data through AI-powered cameras (201) integrated within the system (102). Other vehicles (301) may be moving in the same direction and/or in the opposite direction relative to the mobile unit (300), allowing for comprehensive monitoring in various traffic conditions.

In an embodiment, the AI-powered traffic control system (102) can be designed for installation on vehicles (300) to address gaps in traditional traffic monitoring, ensuring continuous detection and management of traffic violations across multiple lanes and directions. By positioning the system (102) on individual vehicles, it can effectively extend coverage in high-density and underserved areas, facilitating real-time monitoring even in locations where fixed infrastructure may be limited or absent.

Each vehicle (300) can be equipped with the AI-powered traffic control system (102) at an optimal point to maximize visibility and detection of surrounding vehicles (301). This strategic placement can allow the system (102) to monitor a wide field of view, identifying various violations, including mobile phone usage while driving, failure to wear seatbelts, and other unsafe behaviors. The system (102) can be particularly advantageous for maintaining safety standards, as it continuously assesses compliance and provides real-time data to aid in enforcement.

Additionally, the AI-powered traffic control system (102) can assist governmental traffic authorities in managing and regulating traffic flow, ensuring that vehicles operate at optimal times, especially during events or peak work hours, to mitigate congestion and reduce traffic jams. By providing decentralized monitoring and real-time data sharing, the system (102) offers a scalable solution that supports coordinated traffic management and timely responses to violations.

In an embodiment, the AI-powered traffic control system (102) can be designed to operate sustainably by utilizing various power sources. It may draw energy from the vehicle's power supply, wind energy, solar panels, or an advanced internal battery, allowing for uninterrupted operation and reduced dependency on the vehicle's main energy source. This multi-source power capability enhances the system's resilience and enables it to function effectively in diverse environmental and operational conditions.

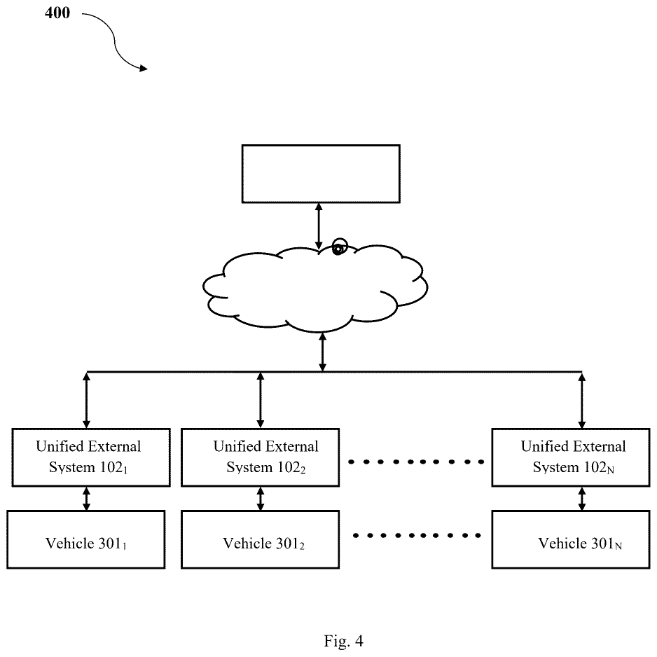

FIG. 4 illustrates the architecture of an AI-powered traffic control system, according to an embodiment. In an embodiment, this architecture may include, but is not limited to, a plurality of AI-powered traffic control systems (102) mounted on vehicles (301), a central server unit (401), and a communication network (402). Each traffic control system (102) may be positioned on top of a vehicle (301) and configured to communicate with the central server unit (401) via the communication network (402), enabling coordinated traffic management.

In an embodiment, the central server unit (401) may be configured to collect and analyze data received from multiple traffic control systems (102) installed on different vehicles (301). By processing this data, the central server unit (401) can make informed decisions regarding traffic control, provide real-time feedback, and assist in optimizing traffic flow and management across various locations. This centralized processing allows for coordinated traffic oversight, enhancing road safety and improving traffic efficiency.

In an embodiment, the communication network (402) may facilitate real-time communication between the central server unit (401) and the various traffic control systems (102) installed on vehicles (301). The communication network (402) can enable seamless data transmission, allowing the central server unit (401) to receive information about traffic conditions, violations, and other critical data from each vehicle. This network may utilize wireless protocols such as 4G, 5G, or V2X (Vehicle-to-Everything) to ensure uninterrupted connectivity and low-latency data exchange.

Each AI-powered traffic control system (102), mounted on its respective vehicle (301), may be configured, in an embodiment, to monitor surrounding traffic, detect traffic violations, and transmit relevant data to the central server unit (401). The system (102) may integrate components such as AI-powered cameras (201), a speed detection device (202), and an adaptive light system (203) to capture and process environmental data in real time. The cameras (201) may identify traffic violations and unsafe driving behaviors, while the speed detection device (202) measures vehicle speeds and detects speed violations. The adaptive light system (203) provides visual feedback to nearby vehicles, thereby enhancing road safety.

In one embodiment, each vehicle (301) equipped with the traffic control system (102) may function as a decentralized traffic monitoring unit, working collectively with the central server unit (401) to ensure comprehensive and distributed traffic management. The central server unit (401) may aggregate data from numerous vehicles (301) to provide a real-time overview of traffic conditions across different regions, enabling more effective decision-making and response to traffic incidents.

In an embodiment, each traffic control system (102) on a vehicle (301) may collect data on traffic conditions, driver behavior, and detected violations through its cameras (201) and speed detection device (202). This data can be transmitted to the central server unit (401) over the communication network (402) for further analysis and action.

In an embodiment, upon receiving data from multiple systems (102), the central server unit (401) may analyze the aggregated information to identify patterns, monitor traffic density, and detect high-risk areas. Based on this analysis, the central server unit (401) can send feedback to individual vehicles (301) or specific regions to optimize traffic flow or enforce traffic regulations.

In one embodiment, when a vehicle's traffic control system (102) detects a violation, such as speeding or tailgating, the system (102) may notify the central server unit (401) and activate its adaptive light system (203) to alert surrounding drivers. This decentralized feedback mechanism can enhance road safety by promoting compliance among drivers near the monitored vehicle (301).

The communication network (402) may allow continuous, bidirectional data flow between each vehicle's traffic control system (102) and the central server unit (401). This dynamic exchange of information supports real-time monitoring, enabling swift adjustments to traffic management strategies based on current conditions.

In an embodiment, the central server unit (401) may employ AI and machine learning algorithms to detect patterns and predict traffic trends based on data from multiple systems (102). This predictive analysis can enable proactive traffic management, allowing the server to identify potential congestion points and recommend rerouting or speed adjustments to prevent bottlenecks.

In an embodiment, the AI-powered cameras (201) on each traffic control system (102) may use real-time object detection to identify specific traffic violations or dangerous driving behaviors. These capabilities, coupled with machine learning, enable the system (102) to continuously improve its accuracy and efficiency in violation detection over time.

In one embodiment, the architecture of this AI-powered traffic control system is designed to be scalable, allowing additional vehicles (301) to be equipped with the traffic control system (102) and connected to the central server unit (401) as needed. This flexibility can make the system adaptable to different urban and rural environments, expanding its coverage and effectiveness without requiring significant infrastructure changes.

In another embodiment, the system (102) may also support modular integration of new components or updates, ensuring compatibility with evolving traffic management needs and advancements in technology.

Together, in an embodiment, the components of this AI-powered traffic control architecture, including the traffic control systems (102) on each vehicle (301), the central server unit (401), and the communication network (402), can form an interconnected ecosystem for real-time traffic monitoring and management. This system enables autonomous, decentralized traffic regulation on civilian vehicles, enhancing road safety and promoting compliance across a wide geographic area without relying solely on traditional infrastructure.

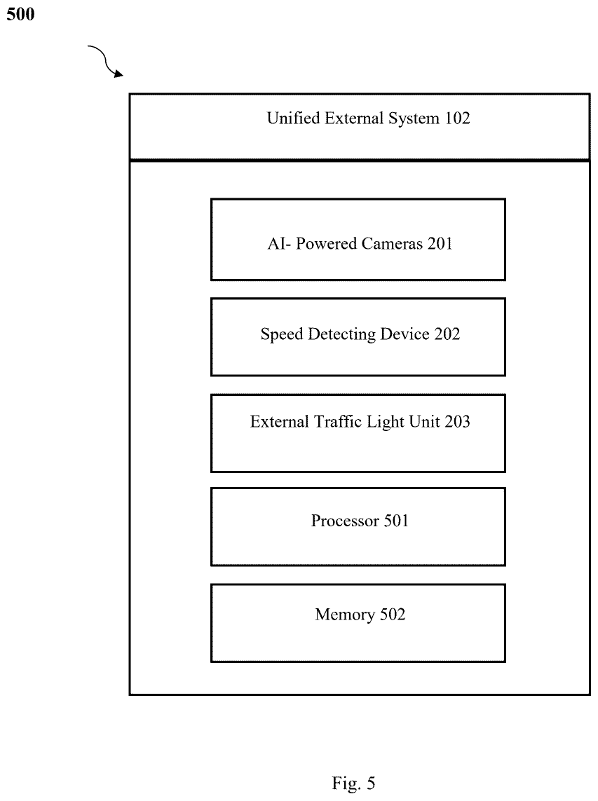

FIG. 5 illustrates a block diagram of the AI-powered traffic control system (102) installed on a vehicle (301), according to an embodiment. In an embodiment, the AI-powered traffic control system (102) may include, but is not limited to, AI-powered cameras (201), a speed detection device (202), an adaptive light system (203), a processor (501), and a memory (502). The system (102) can be configured to perform real-time data analysis and storage, providing traffic monitoring, reporting, and communication capabilities with surrounding vehicles and centralized systems.

In an embodiment, the processor (501) can serve as the central control unit for the AI-powered traffic control system (102). The processor (501) may receive and analyze data from the AI-powered cameras (201), speed detection device (202), and adaptive light system (203). In an embodiment, the processor (501) can use AI algorithms to detect traffic violations and make real-time decisions to control the adaptive light system (203) for feedback to surrounding drivers. Additionally, the processor (501) may be configured to communicate with external servers or centralized traffic management systems, enabling broader traffic control and reporting.

In an embodiment, the memory (502) may store data collected by the AI-powered cameras (201) and speed detection device (202). This data may include recorded video footage, detected violations, speed measurements, and incident records. The memory (502) enables both real-time processing by the processor (501) and longer-term storage for incident analysis and reporting. The stored data can be used to generate reports on traffic violations, accidents, and fault assignments, supporting law enforcement or traffic authorities.

In an embodiment, data from the cameras (201) and speed detection device (202) may be processed by the processor (501) in real-time. The memory (502) can store relevant data for future reference or reporting, allowing detailed records of detected violations and incidents.

Based on analyzed data, in an embodiment, the processor (501) may control the adaptive light system (203) to display specific signals, such as red, orange, or green, to communicate instructions to nearby drivers, enhancing traffic safety around the vehicle.

In an embodiment, the processor (501) may transmit relevant data to centralized traffic management systems via a communication network (402), enabling broader traffic oversight and reporting for enhanced road safety.

In one embodiment, the processor (501) may leverage AI and machine learning algorithms to enhance detection accuracy over time. These algorithms can improve the system's ability to recognize complex traffic patterns, reducing false positives and adapting to new driving behaviors.

In an embodiment, the system (102) may be designed to support modular upgrades, enabling the addition of new components or software updates, making it adaptable to evolving traffic management needs and regulatory standards.

Together, in an embodiment, the components of the AI-powered traffic control system (102) including the AI-powered cameras (201), speed detection device (202), adaptive light system (203), processor (501), and memory (502) work as an integrated solution for decentralized traffic monitoring, control, and reporting. This architecture enables the vehicle (301) to autonomously regulate nearby traffic conditions, enhance road safety, and support centralized traffic management when needed.

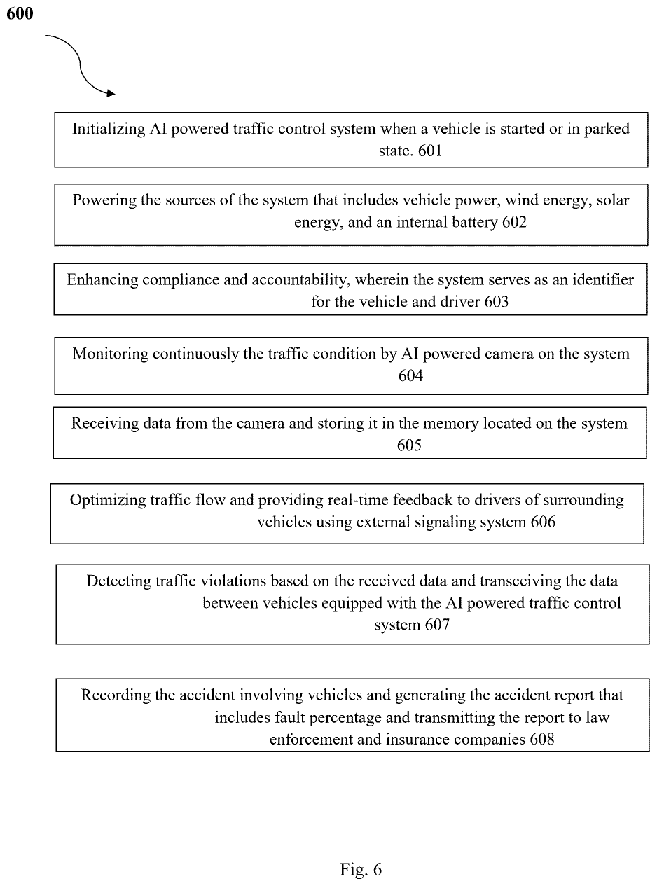

FIG. 6 illustrates a flowchart for a method of implementing an AI-powered traffic control system (102) for enhancing road safety and reducing congestion, according to an embodiment. In an embodiment, this method outlines the sequential steps the system (102) follows to monitor, analyze, and communicate traffic conditions autonomously.

In an embodiment, the AI-powered traffic control system (102) can be initialized when the vehicle (301) is started or when it is in a parked state, allowing the system (102) to operate both in motion and while stationary. This initialization process activates the sensors, cameras, and processing components, preparing the system for real-time monitoring.

In an embodiment, the system (102) is powered by multiple energy sources, which can include the vehicle's battery, wind energy, solar energy, or an internal battery. This redundancy in power sources ensures continuous operation, allowing the system (102) to function without interruption regardless of the vehicle's operational status.

In an embodiment, the system (102) serves as an identifier for the vehicle (301) and driver, which enhances accountability by associating detected violations with specific vehicles and operators. The system (102) may continuously monitor traffic conditions using AI-powered cameras (201), which capture real-time video and image data of the surrounding environment.

In an embodiment, data captured by the AI-powered cameras (201) and speed detection device (202) is sent to the memory (502) for storage. This stored data may include images, videos, speed data, and other relevant information related to detected violations or traffic patterns. Memory (502) enables both real-time analysis and historical record-keeping for incident review.

In an embodiment, the processor (501) analyzes the captured data from the cameras (201) and speed detection device (202) in real time. The processor (501) may use AI algorithms and machine learning to detect various traffic violations, such as speeding, seatbelt non-compliance, reckless driving, lane violations, littering, and malfunctioning vehicle lights. By leveraging advanced detection algorithms, the processor (501) can accurately identify unsafe behaviors and assign fault as necessary.

In an embodiment, the processor (501) can control the adaptive light system (203) to provide real-time feedback to surrounding drivers based on detected traffic violations. The adaptive light system (203) may display color-coded signals—red, orange, and green—to instruct drivers of nearby vehicles to stop, slow down, or proceed. This feedback mechanism enhances road safety by encouraging compliant and safe driving behaviors in real time.

In an embodiment, the system (102) can be configured to communicate with other vehicles equipped with similar AI-powered traffic control systems (102). This data transceiving capability enables the system (102) to exchange traffic information with surrounding vehicles, creating a cooperative network of interconnected vehicles. Through this network, vehicles can share traffic conditions, violations, and safety alerts, allowing for coordinated traffic management.

In an embodiment, the system (102) may detect and record accident data by analyzing sensor inputs, video footage, and speed measurements. The processor (501) can assign fault percentages based on the incident's data, which helps determine the responsibility of involved drivers. This automated fault analysis can be used for post-accident review by relevant authorities.

In an embodiment, the system (102) is configured to transmit collected data, including violation records and accident reports, to external entities such as law enforcement and insurance companies. The reporting may include fault analysis and incident details, which can aid in investigations, claims processing, and regulatory enforcement. The system's ability to store and report incident data provides a valuable resource for post-incident investigations and enhances accountability.

A main advantage of the present disclosure is that it provides an AI-powered traffic control system and method, designed to enhance road safety and reduce congestion by autonomously monitoring traffic conditions.

Another advantage of the present disclosure is that the AI-powered traffic control system is mounted on civilian vehicles, enabling decentralized traffic monitoring and ensuring widespread coverage without the need for dedicated government-operated vehicles.

Yet another advantage of the present disclosure is that an AI-powered external traffic light system is integrated with the traffic control system, providing real-time feedback to surrounding vehicles through color-coded signals, thereby promoting safer driving behaviors and improving road safety.

Still another advantage of the present disclosure is that the system is capable of detecting a wide range of traffic violations, including but not limited to littering, seatbelt non-compliance, and the use of mobile phones while driving. This comprehensive violation detection capability enhances traffic law enforcement and accountability.

Yet another advantage of the present disclosure is that the system can be powered by multiple energy sources, which may include the vehicle's battery, solar energy, wind energy, and an internal battery. This versatility in power sources ensures uninterrupted operation of the system, irrespective of vehicle status.

Still another advantage of the present disclosure is that the system can record accident data, including fault percentage analysis, and transmit this information to law enforcement and insurance companies. This automated reporting capability aids in post-incident investigations and supports accurate and efficient claims processing.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. An AI-powered traffic control system for autonomous monitoring and management of traffic violations and conditions, the system (102) being mounted on a vehicle (301) and comprising:
at least one AI-powered camera (201) configured to capture images or video of the surrounding environment and detect traffic violations, traffic conditions, and unsafe driving behaviors using image recognition and machine learning algorithms;
a speed detection device (202) configured to measure the speed of surrounding vehicles and identify instances of speeding;
an adaptive light system (203) configured to provide real-time visual feedback to surrounding vehicles by displaying color-coded signals based on detected traffic conditions, including green for proceed, orange for caution, and red for stop;
a processor (501) operatively connected to the AI-powered camera (201), speed detection device (202), and adaptive light system (203), the processor (501) being configured to:
analyse data from the AI-powered camera (201) and speed detection device (202) to detect traffic violations and traffic conditions,
control the adaptive light system (203) to display real-time feedback based on detected conditions, and
communicate data to external systems, including central servers or nearby vehicles, for coordinated traffic management;
a memory (502) operatively connected to the processor (501), the memory (502) configured to store data related to detected violations, traffic conditions, and accident information;
wherein the AI-powered traffic control system (102) is configured to operate autonomously both when the vehicle (301) is in motion and when stationary, allowing continuous monitoring, real-time violation detection, and autonomous reporting to external entities.

2. The AI-powered traffic control system (102) of claim 1, wherein the at least one AI-powered camera (201) is positioned on the vehicle (301) at one or more locations selected from the group consisting of: the roof, front bumper, rear bumper, windshield, and rear window, to provide optimal visibility of the surrounding environment for detecting traffic violations, traffic conditions, and unsafe driving behaviours.

3. The AI-powered traffic control system (102) of claim 1, wherein the adaptive light system (203) is configured to provide real-time visual feedback to surrounding vehicles by dynamically adjusting color-coded signals based on detected traffic conditions and violations, thereby promoting safe driving behaviours in response to the specific circumstances detected.

4. The AI-powered traffic control system (102) of claim 1, wherein the processor (501) is configured to analyze data from the AI-powered camera (201) and the speed detection device (202) in real time to detect both traffic violations and traffic conditions, enabling timely responses to identified risks and the provision of feedback through the adaptive light system (203).

5. The AI-powered traffic control system (102) of claim 1, wherein the AI-powered camera (201) is configured to operate in low-light or nighttime conditions using noise reduction and object detection algorithms, ensuring accurate detection of traffic violations and conditions regardless of ambient lighting.

6. The AI-powered traffic control system (102) of claim 1, wherein the AI-powered camera (201) incorporates privacy-protection algorithms to selectively capture data, anonymizing sensitive information by blurring faces and license plates not directly involved in detected violations.

7. The AI-powered traffic control system (102) of claim 1, wherein the AI-powered camera (201) is configured for event-based recording, storing data only upon detection of a traffic violation or unsafe driving behaviour to optimize data storage and processing efficiency.

8. The AI-powered traffic control system (102) of claim 1, wherein the speed detection device (202) is configured to monitor vehicle speeds across multiple lanes and varying traffic densities, thereby enabling accurate detection of speeding violations in diverse traffic conditions.

9. The AI-powered traffic control system (102) of claim 1, wherein the speed detection device (202) is configured to detect speed fluctuations and distinguish between temporary speed changes and actual speeding violations, minimizing false-positive detections.

10. The AI-powered traffic control system (102) of claim 1, wherein the adaptive light system (203) includes directional indicators to target specific vehicles, providing tailored visual feedback to vehicles following too closely or engaging in unsafe driving behaviours.

11. The AI-powered traffic control system (102) of claim 1, wherein the adaptive light system (203) is configured to dynamically adjust brightness levels to ensure visibility in various lighting and weather conditions, thereby enhancing safety for surrounding drivers.

12. The AI-powered traffic control system (102) of claim 1, wherein the processor (501) is further configured to assign fault in detected accidents by analysing recorded data from the AI-powered camera (201) and speed detection device (202), supporting post-incident review and investigation.

13. The AI-powered traffic control system (102) of claim 1, wherein the processor (501) is configured to communicate with a central traffic management system or nearby vehicles via a wireless communication interface, enabling coordinated traffic management and real-time data exchange.

14. The AI-powered traffic control system (102) of claim 1, wherein the adaptive light system (203) is configured to provide sequential signalling to communicate complex instructions to surrounding drivers, the sequential signalling comprising multiple stages or patterns that adapt based on detected traffic conditions or violations, thereby enhancing driver awareness and promoting safe driving behaviours.

15. A method of implementing an AI-powered traffic control system (102) on a vehicle (301) for autonomous monitoring and managing traffic conditions and violations, the method comprising:
initializing the AI-powered traffic control system (102) upon starting the vehicle (301) or when the vehicle (301) is stationary;
capturing images or video of the surrounding environment using at least one AI-powered camera (201) to detect traffic violations, traffic conditions, and unsafe driving behaviours based on image recognition and machine learning algorithms;
measuring the speed of surrounding vehicles using a speed detection device (202) to identify instances of speeding;
analysing data from the AI-powered camera (201) and speed detection device (202) using a processor (501) to detect traffic violations and conditions in real time;
providing real-time visual feedback to surrounding drivers based on detected traffic conditions and violations through an adaptive light system (203);
transmitting detected violations, traffic conditions, and other relevant data to external systems, including central servers or nearby vehicles, to enable coordinated traffic management.

16. The method of claim 15, further comprising dynamically adjusting the visual feedback provided by the adaptive light system (203) by using color-coded signals and sequential signalling patterns based on the nature of detected traffic violations or unsafe driving behaviours, thereby promoting safe driving practices among surrounding drivers.

17. The method of claim 15, further comprising recording data selectively based on event detection, wherein images, video, or speed data are stored in memory (502) only when a traffic violation or unsafe driving behavior is identified, optimizing data storage efficiency.

18. The method of claim 15, further comprising anonymizing sensitive information captured by the AI-powered camera (201) through privacy-protection algorithms, including blurring faces and license plates of individuals or vehicles not directly involved in detected traffic violations, thereby ensuring compliance with privacy standards.
